(19) United States
(12) Patent Application Publication
(10) Pub. No.: US 2020/0158222 A1
(43) Pub. Date: May 21, 2020

(54) Novel Product of Wheel Hub Assembly for Damping and Noise Reduction

(71) Applicant: Germany Hong Gmbh, Frankfurt (DE)

(72) Inventor: Guoli Xu, Fremont, CA (US)

(73) Assignee: Germany Hong Gmbh, Frankfurt (DE)

(21) Appl. No.: 16/198,740

(22) Filed: Nov. 21, 2018

(51) Int. Cl. F16H 55/14; F16D 41/30; B60B 27/04

(52) U.S. Cl. CPC F16H 55/14; B60B 1/04; B60B 27/042; F16D 41/30

(57) ABSTRACT

This invention discloses a novel product of a Wheel Hub Assembly for damping and noise reduction. It absorbs vibration and noise of brake rotor and brake drum in the braking process by changing flange face structure as well as adding damping coating. During the production, the flange face of the Wheel Hub Assembly is equipped with one or several technical groove(s) while a damping coating is designed to reduce vibration and noise. The damping coating is made of rubber materials, composite materials, damping coating materials or high polymer materials. In this invention, the damping coating is added between wheel hub and brake disk or brake drum. This can not only absorb a part of noise, but also reduce braking vibration to decrease the noise.

This invention discloses a novel product of a Wheel Hub Assembly (WHA) for damping and noise reduction in the technical field of bearing production.

### BACKGROUND

Vehicle brake system's noise and vibration have been an intricate problem that is difficult to solve. Generally speaking, current solutions are aimed at resolving the problem of noise and vibration from the aspects of braking parts, such as caliper, brake lining, brake rotor or brake drum. A Wheel Hub Assembly (WHA) is an important part of braking system, nevertheless, there are no effective methods that can address the problem of noise and vibration reduction from the perspective of a wheel hub assembly.

In U.S. Pat. No. 4,405,032, one form of a wheel hub assembly is disclosed. In that arrangement, a wheel hub assembly includes a tubular sharped hub member and a universal joint member for rotating coaxially. A filler material is filled in between to insulate heat transfer and to reduce noise and vibration damping effect.

### DETAILED DESCRIPTION OF THE INVENTION

The goal of this invention is to provide a new product of a wheel hub assembly for damping and noise reduction, which can contribute to less vibration and noise when said wheel hub assembly is working. The invention offers technical schemes as below:

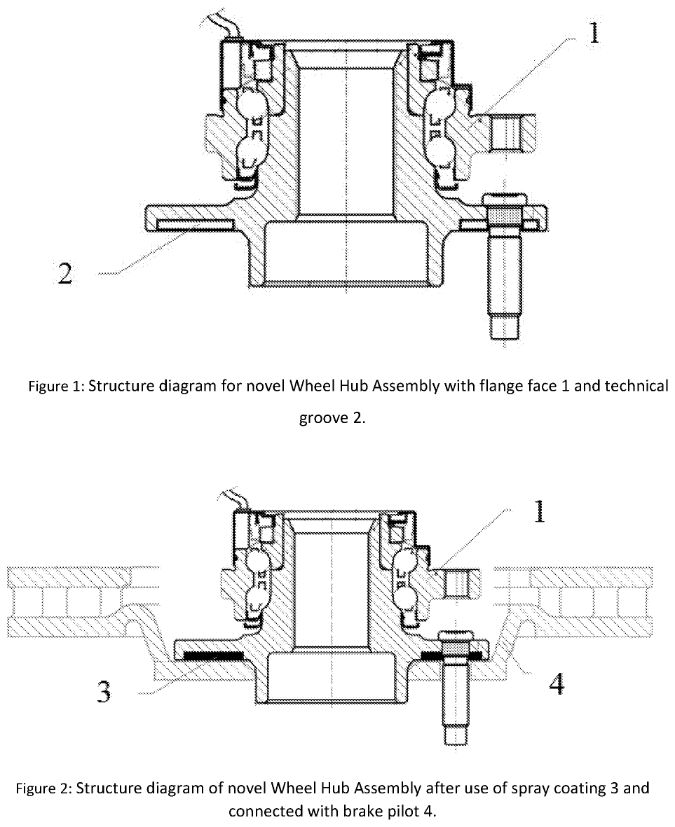

Said novel product of the Wheel Hub Assembly aims to absorb vibration and noise of brake rotor and brake drum in the braking process, as shown in FIG. 1. To achieve that, the new wheel hub assembly has altering a flange face structure of the wheel hub assembly as well as adding a damping coating. During production, the flange face 1 of the wheel hub assembly is equipped with one or several technical groove(s) 2, inside which the damping coating 3 is designated to reduce vibration and noise. FIG. 1 describes the groove location of the Wheel Hub Assembly and FIG. 2 describes the Wheel Hub Assembly with damping coating filled.

Said novel product of Wheel Hub Assembly for damping and noise reduction has the following details:

Said flange face is equipped with one or several technical groove(s) 2. One embodiment of said technical groove dimensions is that the boundary's lower limit of technical groove is 2 mm greater than brake pilot 4 diameter; the upper limit of coating boundary is 2 mm smaller than flange diameter; and the said groove is 0.5 mm-7.0 mm in depth.

Said damping coating is formed by coating rubber materials, composite materials, damping coating materials or high molecular polymer materials inside the said technical groove. One embodiment of coating is by spray coating. Heat can be required for damping coating solidification or drying. The depth and width of coating is smaller than or equal to the width of said technical groove.

In addition, said flange face in this invention can be made of different materials with similar effect to achieve noise and vibration reduction purpose. Said technical grooves can be grooves and holes with different shapes on flange face with similar damping coating and achieve similar results. Furthermore, the coating on other parts of flange face also demonstrates similar improvement. Instead of changing braking parts like caliper, brake lining, brake rotor or brake drum to address the problem of noise and vibration, this invention alters flange face structure of the wheel hub assembly and increases damping coatings in a creative way. The damping coating on the wheel hub assembly may touch or not touch brake rotor or brake drum.

The beneficial results of this invention further include the following situation: Brake rotor and brake drum will have noise and vibrate because of position deviation and vibration resulting from external force in vehicle's braking process. The damping coating is added between wheel hub and brake disk or brake drum. This can not only absorb a part of noise, but also reduce braking vibration to decrease the noise.

In a preferred embodiment, a specific implementation mode of this invention will be described for better understanding of this invention as followed.

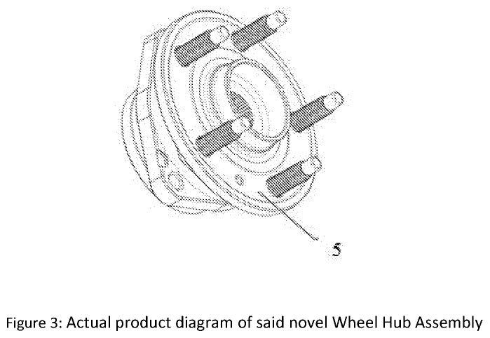

The novel product of wheel hub assembly for damping and noise reduction has the following steps: (1) The flange face above is equipped with one or several technical groove(s); the boundary's lower limit of technical groove is 2 mm greater than brake pilot diameter; the upper limit of coating boundary is 2 mm smaller than flange diameter; and the technical groove is 0.5 mm-7.0 mm in depth. (2) The rubber materials, composite materials, damping coating materials and high polymer materials probably needs heating for solidification or drying. The depth and width of coating is smaller than or equal to those of technical groove, and the results are shown by FIG. 2. (3) The actual product example manufactured is shown by FIG. 3.

The above is the preferential implementation mode of this invention. It is worth noticing that on the premise of following the principle of this invention, ordinary technicians in this technical field may make improvements and modifications, which also fall into the protective scope of this invention.

### DETAILED DESCRIPTION OF THE FIGURES

FIG. 1 Structure diagram for novel Wheel Hub Assembly with flange face 1 and technical groove 2.

FIG. 2 Structure diagram of novel Wheel Hub Assembly after use of spray coating 3 and connected with brake pilot 4.

FIG. 3 Actual product diagram of said novel Wheel Hub Assembly

We claim:

1. A novel product of Wheel Hub Assembly for damping and noise reduction comprising:
a flange face structure with technical grooves;
and a damping coating designated to reduce vibration and noise.

2. A novel product of Wheel Hub Assembly for damping and noise reduction wherein the flange face structure comprises one or several technical groove(s).

3. A novel product of Wheel Hub Assembly for damping and noise reduction wherein the damping coating is added for vibration and noise reduction by spraying and related coating methods.

4. The flange face structure as set forth in claim 2, wherein one or several technical groove(s) locations has a boundary's lower limit of no less than 2 mm greater than brake pilot diameter.

5. The flange face structure as set forth in claim 2, wherein one or several technical groove(s) is 0.5 mm-7.0 mm in depth.

6. The damping coating as set forth in claim 3, wherein the upper limit of spray coating boundary is no less than 2 mm smaller than flange diameter.

7. The damping coating as set forth in claim 3, wherein the depth and width of coating is smaller than or equal to those of technical groove.

8. The damping coating as set forth in claim 3, wherein the coating materials can be selected from rubber materials, composite materials, damping coating materials or high molecular polymer materials, and can be heated for solidification or drying according to technical conditions.
